(19) United States
(12) Patent Application Publication
(10) Pub. No.: US 2007/0043893 A1
(43) Pub. Date: Feb. 22, 2007

(54) Bus communication apparatus and bus communication method

(75) Inventor: Takanori Ishii, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/281,381

(22) Filed: Nov. 18, 2005

(30) Foreign Application Priority Data
Aug. 16, 2005 (JP) 2005-235897

(51) Int. Cl. G06F 13/00

(52) U.S. Cl. 710/302

(57) ABSTRACT

A bus communication apparatus and a bus communication method are provided, in which data transfer via a bus is not interrupted and no noise is generated in any signal on the bus. The apparatus comprises a bus signal terminal that can be connected to the bus of the external apparatus; a device that communicates with the external apparatus through the bus; a driver that is connected at an input terminal to the bus signal terminal and at an output terminal to the device, has an input impedance much higher than the impedance that the bus signal terminal has with respect to the input terminal and an output impedance much lower than the impedance that the device has with respect to the output terminal, and operates in order to decrease a potential difference between the input terminal and the output terminal; a switch that connects the bus signal terminal to the device; and a control unit that instructs the driver to start operating, then instructs the switch to perform connection and instructs the driver to stop operating, after the bus signal terminal is connected to the external apparatus.

### BACKGROUND OF THE INVENTION

1. Field of the Invention

This invention relates to a bus communication apparatus and a bus communication method, both designed to connect a device to an external apparatus via the bus of the external apparatus while the bus is operating in the external apparatus.

2. Description of the Related Art

In data-processing apparatuses developed in recent years, a peripheral component interconnect (PCI) bus is used to connect an extension device to the motherboard. A daughter board for the extension device is inserted in the PCI-bus connector provided on the motherboard. FIG. 4 is a perspective view illustrating how the daughter board is inserted into the motherboard in the data-processing apparatus.

When the daughter board is inserted into the motherboard while the PCI bus is active, that is, when active insertion is carried out, noise may be generated in the signal on the bus, due to the wiring capacitance of the daughter board that is inserted or the like. The noise may cause an error in the signal that is being transferred by the bus. Hitherto, the signal transfer through the bus is temporarily stopped in order to prevent this error. If the operation of the PCI bus is stopped, however, the efficiency of signal transfer through the bus will inevitably decrease.

To achieve the active insertion without stopping the operation of the PCI bus, one of the following methods is employed.

In the first method, a switch is used, shortening the length of a wire that contacts the moment the daughter board is inserted. The load capacity of the wire therefore decreases, thereby suppressing the noise that is generated at the time of the active insertion.

In the second method, the bus signal on the side of the daughter board is held at a predetermined intermediate potential. The potential difference at the time of active insertion is thereby minimized, thus suppressing the noise. In the third method, a switch is provided on the bus, and a control circuit monitors the control signal on the PCI bus. When no data is transferred through the PCI bus, the control circuit turns on the switch, connecting the PCI bus.

Jpn. Pat. Appln. Laid-Open Publication No. 5-289788 (Pat. Document 1) is known as prior art relevant to the present invention. The publication discloses an electric circuit that can be connected while being supplied with a current and a method of connecting the circuit. The circuit, which is to be hot-plugged, has a circuit network with preset conditions. The parasitic input capacitance of the circuit is partly pre-charged before the circuit is hot-plugged, thereby to suppress the influence of the transition state of the circuit.

In the first method described above, however, a current flows from the motherboard to devices, or from the devices to the motherboard, generating noise in the bus signal, if the devices have a larger load capacitance than the one contemplated at the time of designing the devices because the devices connected are numerous or the wires connecting the switches to the devices are long.

The second method will be described in detail.

FIG. 5 is a block diagram of a data-processing apparatus that employs the second method. This data-processing apparatus comprises a motherboard 1 and a daughter board 102. The motherboard 1 has a PCI device 11 and a connector 19. The daughter board 102 comprises a PCI device 21, a control unit 131, a bus switch unit 132, a plurality of bus signal lines 33 and 134, a switch controlling signal line 35, and a connector 29. The connector 19 comprises a plurality of bus signal terminals 15, a ground terminal 16, a power supply terminal 17, and bus signal lines 13. The connector 29 comprises a plurality of bus signal terminals 25, a ground terminal 26, and a power supply terminal 27. The bus switch unit 132 comprises a plurality of switches 41, a plurality of resistors 142 and 143. The bus signal terminals 15, bus signal terminals 25, bus signal lines 33, bus signal lines 134, switches 41, resistors 142 and resistors 143 are provided in number that corresponds to the width of the bus.

The switch controlling signal that passes through the switch controlling signal line 35 is a signal that the control unit 131 uses to control the switches 41. The switch controlling signal turns on the switches 41 when it is at high level.

How the data-processing apparatus operates when the active insertion of the daughter board is performed by using the second method hitherto known. Before the daughter board 102 is inserted, the switches 41 are off, the bus signal lines 134 are at a potential set by the resistors 142 and 143. More precisely, they are set at a preset potential that is halfway between high level and low level.

The terminals provided in the connector 29 are different in length. The longest is the ground terminal 26, and the shortest is the bus signal terminals 25. The power supply terminal 27 has an intermediate length. Hence, the ground terminal 26, the power supply terminal 27, and the bus signal terminals 25 are sequentially connected, in the order they are mentioned, as the connector 29 is inserted into the connector 19. Thus, the ground terminal 16 and the ground terminal 26 contact first, connecting the ground line. Next, the power supply terminal 17 and the power supply terminal 27 contact each other, connecting the power supply line. Power is thereby supplied to the control unit 131 and PCI device 21, activating the control unit 131 and PCI device 21. Finally, the bus signal terminals 15 contact the bus signal terminals 25, connecting the bus signal lines 13 to the bus signal lines 33.

FIG. 6 is a timing chart showing waveforms that the signals have when the active insertion of the daughter board is achieved by the second method, i.e., a conventional method. The abscissa indicates time, while the ordinate indicates potential. The waveforms of the switch controlling signal, bus signal in the motherboard and bus signal in the daughter board are sequentially depicted, from top to bottom. The switch controlling signal is on the switch controlling signal line 35, the bus signal in the motherboard is on the bus signal lines 13, and the bus signal in the daughter board is on the bus signal lines 134.

Before the daughter board 102 is inserted into the motherboard 1, the switch controlling signal remains at low level, turning off the switches 41. The bus signal on the side of the daughter board is held at a preset intermediated potential. After the daughter board 102 is inserted, the control unit 131 set the switch-control signal at high level, turning on the switches 41. Then, the bus signal on the side of the daughter board has its potential gradually changed to the bus signal on the side of the motherboard. The moment the switches 41 are turned on, a potential difference remains between the bus signal on the side of the motherboard and the bus signal on the side of the daughter board. Therefore, noise is generated in the bus signal on the side of the motherboard. Noise is inevitably generated because a potential difference develops between the bus signal on the side of the daughter board and the bus signal on the side of the motherboard no matter whether the signal on the side of the motherboard is at high or low level.

The bus signal lines 134 are held at the preset potential at all times. Therefore, any signal being transferred and in normal state inevitably has its potential drawn to a predetermined potential.

The third method will be described in detail.

FIG. 7 is a block diagram of a data-processing apparatus that employs the third method. The components identical or equivalent to those shown in FIG. 5 are designated at the same reference numerals and will not be described. As comparison with FIG. 5 may reveal, the apparatus of FIG. 7 has a daughter board 202 in place of the daughter board 102. Further, as compared with the apparatus of FIG. 5, the daughter board 202 has a control unit 231 in place of the control unit 131, a bus switching unit 232 in place of the bus switch unit 132, and bus signal lines 34 in place of the bus signal lines 134. As compared with the bus switch unit 132, the bus switch unit 232 need to have neither the resistors 142 nor the resistors 143.

The switch controlling signal passing through the switch controlling signal line 35 is a signal which the control unit 231 controls the switches 41. When the switch controlling signal is at high level, the switches 41 are turned on.

It will be explained how the apparatus operates when the daughter board is inserted by the third method. FIG. 8 is a timing chart showing waveforms that the signals may have when the active insertion of the daughter board is achieved by the third method that is a conventional method, too. As in FIG. 6, the abscissa indicates time, while the ordinate indicates potential. The waveforms of the switch controlling signal, PCI bus control signal, bus signal in the motherboard and bus signal in the daughter board are sequentially depicted, from top to bottom. The PCI bus control signal is used in the PCI device 21 to control the transfer of signals through the bus. It is at low level while any signal is being transferred through the bus. The switch controlling signal is on the switch controlling signal line 35, the bus signal in the motherboard is on each bus signal line 13, and the bus signal in the daughter board is on each bus signal lines 34.

After the daughter board 202 is inserted, the control unit 231 monitors the PCI bus control signal that is used in the PCI device 21. When the PCI bus control signal reaches high level, that is, when the data transfer via the bus is interrupted, the switch controlling signal is set to high level. The switches 41 are turned on, and the bus signal on the side of the daughter board has its potential approaching that of the bus signal on the side of the motherboard. At this time, a potential difference remains between the bus signal on the side of the motherboard and the bus signal on the side of the daughter board. Hence, noise develops in the bus signal on the side of the motherboard, but no errors are made because no signals are transferred via the bus. However, the control unit 231 must monitor the PCI bus control signal and control the switches. Therefore, the circuit scale increases. Further, after the daughter board 202 is inserted, the switches 41 cannot be turned on until the data transfer via the bus is interrupted. Inevitably, a waiting time develops in the data transfer through the bus.

According to Pat. Document 1, the devices connected by the bus must be adjusted in potential and impedance and both be dedicated circuits.

### SUMMARY OF THE INVENTION

The present invention has been made in order to solve the problems pointed out above. An object of the invention is to provide a bus communication apparatus and a bus communication method, both designed to connect a device to an external apparatus via the bus, without interrupting the data transfer via the bus and to reduce the noise generated during the data transfer via the bus.

To achieve the object, a bus communication apparatus according to this invention is designed to connect a device to an external apparatus via the bus of the external apparatus, thereby to perform communication with the external apparatus, while the bus is operating in the external apparatus. The bus communication apparatus comprises: a bus signal terminal that can be connected to the bus of the external apparatus; a device that communicates with the external apparatus through the bus; a driver that is connected at an input terminal to the bus signal terminal and at an output terminal to the device, has an input impedance much higher than the impedance that the bus signal terminal has with respect to the input terminal and an output impedance much lower than the impedance that the device has with respect to the output terminal, while the bus signal terminal remains connected to the external apparatus, and operates in accordance with an instruction supplied externally, in order to decrease a potential difference between the input terminal and the output terminal; a switch that connects the bus signal terminal to the device in accordance with a connection instruction supplied externally; and a control unit that instructs the driver to start operating, then instructs the switch to perform connection and instructs the driver to stop operating, after the bus signal terminal is connected to the external apparatus.

In the bus communication apparatus according to the invention, the control unit instructs the driver to start operating, after the device is prepared to operate.

In the bus communication apparatus according to the invention, the control unit waits for a predetermined time after instructing the driver to start operating, and then instructs the switch to perform the connection.

In the bus communication apparatus according to this invention, the control unit instructs the driver to stop operating, immediately after instructing the switch to perform the connection.

In the bus communication apparatus according to the present invention, the control unit measures the predetermined time on the basis of a clock signal that the device uses.

In the bus communication apparatus according to the invention, the predetermined time is half the cycle of the clock signal.

A bus communication method according to this invention is designed for use in a bus communication apparatus that is designed to connect a device to an external apparatus, thereby to perform communication with the external apparatus, while a bus is operating in the external apparatus. The method comprises: a bus-signal terminal connecting step that connects a bus signal terminal provided in the bus communication apparatus, to the external apparatus; a driver starting step that causes a driver to start operating, the driver being connected at an input terminal to the bus signal terminal and at an output terminal to the device that communicates with the external apparatus, having an input impedance much higher than the impedance that the external apparatus has with respect to the input terminal and an output impedance much lower than the impedance that the device has with respect to the output terminal, and being designed to operate in accordance with an instruction supplied externally, in order to decrease a potential difference between the input terminal and the output terminal; a switch connecting step that causes a switch to connect the bus signal terminal to the device in accordance with a connection instruction supplied externally; and a driver-stopping step that causes the driver to stop operating.

In the bus communication method according to the invention, the driver starting step is performed after the device is prepared to operate.

In the bus communication method according to this invention, the switch connecting step is performed upon lapse of a predetermined time after the driver starting step is performed.

In the bus communication method according to the invention, the driver-stopping step is performed immediately after the switch connecting step is performed.

In the bus communication method according to this invention, the predetermined time is measured on the basis of a clock signal that the device uses.

In the bus communication method according to the present invention, the predetermined time is half the cycle of the clock signal.

In the present invention, the potential difference between the ends of the switch provided on the bus signal line is maintained at a small value. Noise generated in the bus signal line whenever the switch is connected will be reduced. Hence, the switch connection can be performed before the data transfer via the bus stops, and the PCI bus control signal need not be monitored. Further, the cost can be reduced because the potential of the daughter board need not be adjusted in accordance with the potential of the motherboard.

### BRIEF DESCRIPTION OF THE DRAWINGS

FIG. 1 is a block diagram showing a configuration that a data-processing apparatus according to this invention may have;

FIG. 2 is a flowchart illustrating a sequence of operation that a daughter board performs when its active insertion is carried out in the present invention;

FIG. 3 is a timing chart that shows waveforms that signals may have when the active insertion of the daughter board is achieved in the present invention;

FIG. 4 is a perspective view illustrating how the daughter board is inserted into the motherboard in a data-processing apparatus;

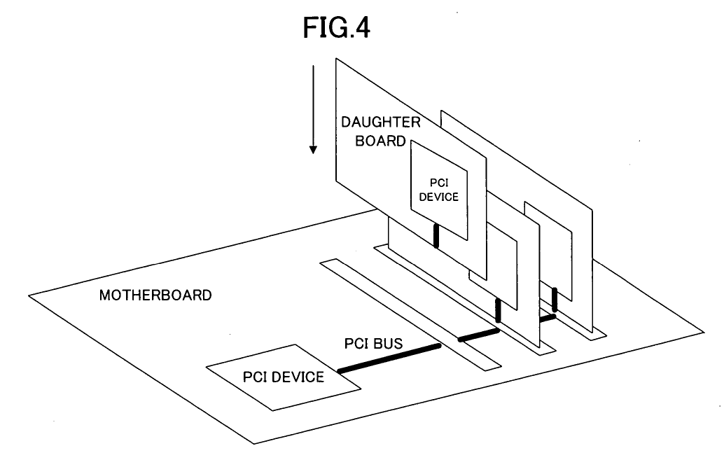

FIG. 5 is a block diagram of a data-processing apparatus that employs the second method described above;

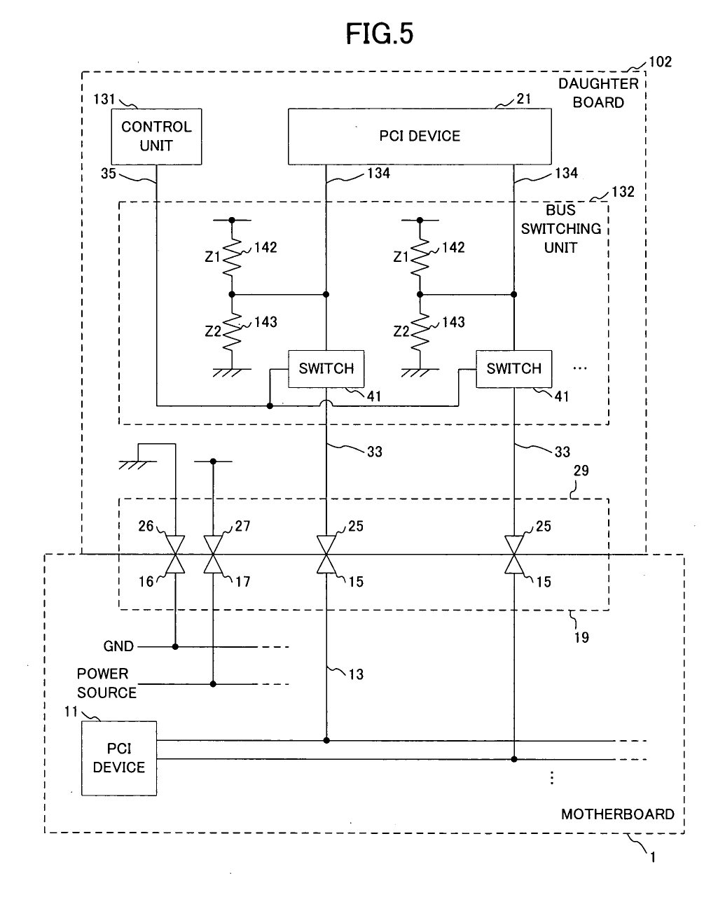

FIG. 6 is a timing chart showing waveforms that signals have when the active insertion of the daughter board is achieved by the second method described above;

FIG. 7 is a block diagram of a data-processing apparatus that employs the third method described above; and

FIG. 8 is a timing chart showing waveforms that the signals may have when the active insertion of the daughter board is achieved by the third method described above.

### DETAILED DESCRIPTION OF THE PREFERRED EMBODIMENTS

An embodiment of this invention will be described, with reference to the accompanying drawings.

The embodiment is a data-processing apparatus, in which a PCI bus is used as extension bus and the daughter board is inserted into the motherboard, in active state, that is, while it is operating.

First, the data-processing apparatus will be described in terms of configuration.

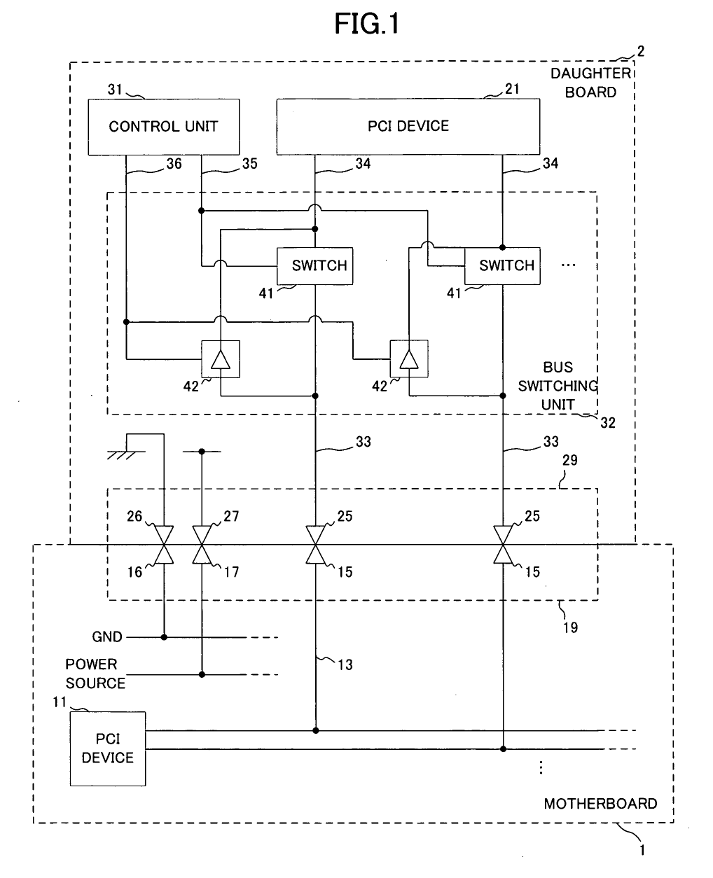

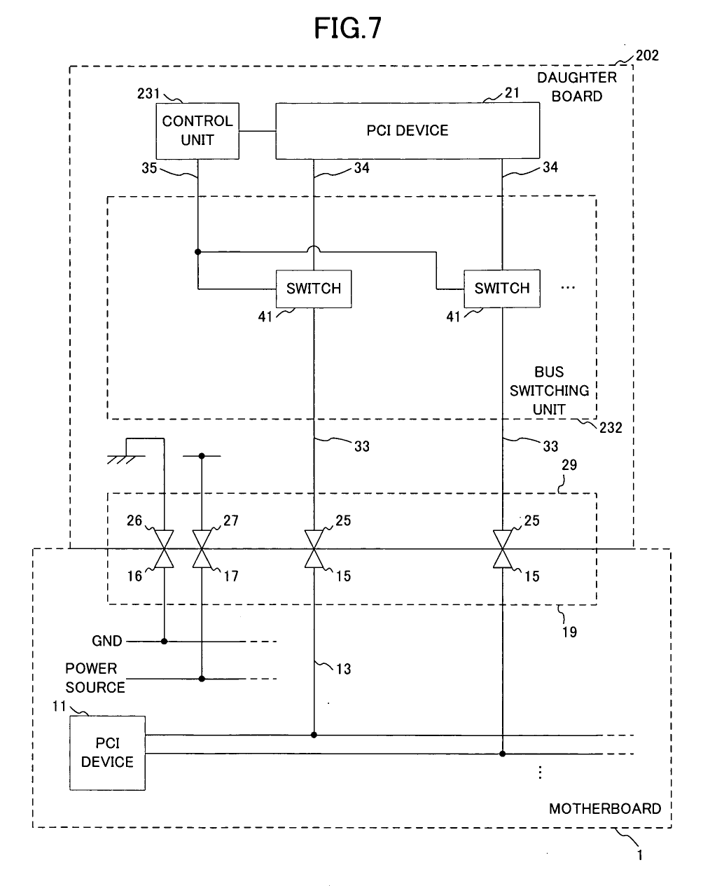

FIG. 1 is a block diagram showing the configuration of the data-processing apparatus according to this invention. The components identical or equivalent to those shown in FIG. 7 are designated at the same reference numerals and will not be described. As comparison with FIG. 7 may show, the apparatus of FIG. 1 has a daughter board 2 in place of the daughter board 202. Further, as compared with the daughter board 202, the daughter board 2 has a control unit 31 in place of the control unit 231, a bus switching unit 32 in place of the bus switch unit 232, and a driver control signal line 36. As compared with the bus switch unit 232, the bus switching unit 32 has a plurality of drivers 42. The drivers 42 are provided in number that corresponds to the width of the bus.

The switch controlling signal passing through the switch controlling signal line 35 is a signal that the control unit 31 uses to control the switches 41. At high level, the switch controlling signal turns the switches 41 on.

The driver controlling signal on the driver control signal line 36 is a signal that the control unit 31 uses to control the drivers 42. At high level, the driver controlling signal turns the drivers 42 on. Thus turned on, the drivers 42 connect the bus signal lines 34 to the input terminal, and the bus signal line 35 to the output terminal. As long as the daughter board 2 is connected to the motherboard 1, the drivers 42 have input impedance much higher than the impedance that the bus signal lines 33 have with respect to the input terminal, and output impedance much lower than the impedance that the bus signal lines 34 have with respect to the output terminal. Hence, the drivers 42 are circuits, each decreasing the potential difference between the input and output terminals when the driver control signal line 36 extending form the control unit 31 is set to high level. The drivers 42 may be circuits that are used as buffers.

It will be described how the daughter board operates when it undergoes active insertion.

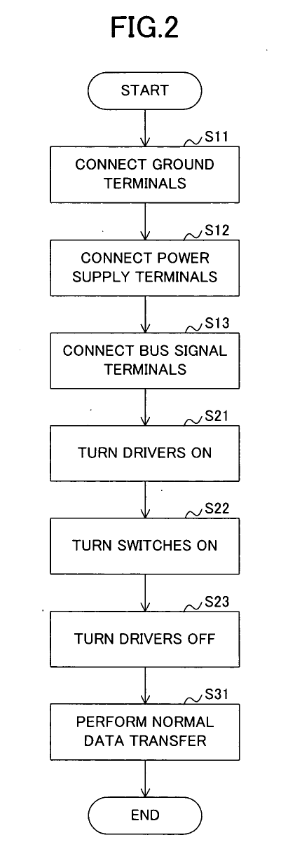

FIG. 2 is a flowchart that illustrates a sequence of operation that the daughter board performs when its active insertion is carried out. Before the daughter board 2 is inserted, the switches 41 are off and the drivers 42 are off. When the daughter board 2 is inserted into the motherboard 1, the flow is started.

As the connector 29 is inserted into the connector 19, the ground terminal 26 is connected to the ground terminal 16 (S11), then the power supply terminal 27 is connected to the power supply terminal 17 (S12), and finally the bus signal terminals 25 are connected to the bus signal terminals 15 (S13).

Thereafter, the control unit 31 and the PCI device 21 are prepared to operate, the control unit 31 sets the driver controlling signal to high level, thus turning the drivers 42 on (S21). As a result, the bus signal lines 33 and the bus signal lines 34 are set to the same potential. As indicated above, the drivers 42 have sufficiently high input impedance. Hence, the circuits on the motherboard 1, which are provided on the input side of the drivers 42, are not influenced even when the drivers 42 are turned on.

Upon lapse of a predetermined time, the control unit 31 sets the switch controlling signal to high level. The switches 41 are therefore turned on (S22). The bus signal lines 33 are thereby connected to the bus signal lines 34. The control unit 31 may utilize the clock signal that the PCI device 21 uses. In this case, the predetermined time is half the cycle of the clock signal and the control unit 31 performs step S21 at the leading edge of the clock signal and performs step S22 at the trailing edge of the clock signal.

Subsequently, the control unit 31 immediately sets the driver control signal to low level, thereby turning off the drivers 42 (S23). The PCI device 21 starts transferring data in a normal way to the PCI device 11 (S31). Then, the flow is terminated.

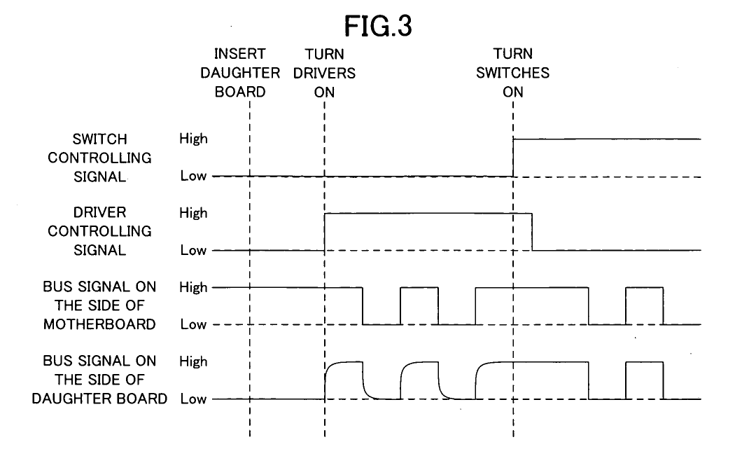

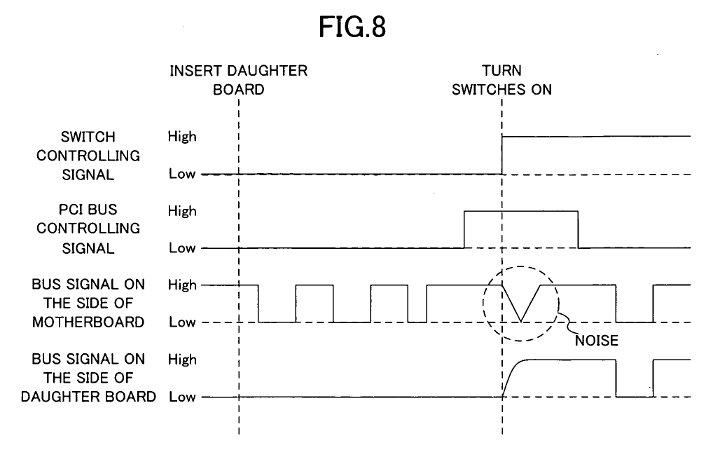

FIG. 3 is a timing chart that shows waveforms that signals may have when the active insertion of the daughter board is achieved. As in FIG. 8, the abscissa indicates time, while the ordinate indicates potential. The waveforms of the switch controlling signal, driver controlling signal, bus signal in the motherboard and bus signal in the daughter board are sequentially depicted, from top to bottom. The switch controlling signal is on the switch controlling signal line 35, the driver controlling signal is on the driver control signal line 36, the bus signal in the motherboard is on the bus signal lines 13, and the bus signal in the daughter board is on the bus signal lines 34.

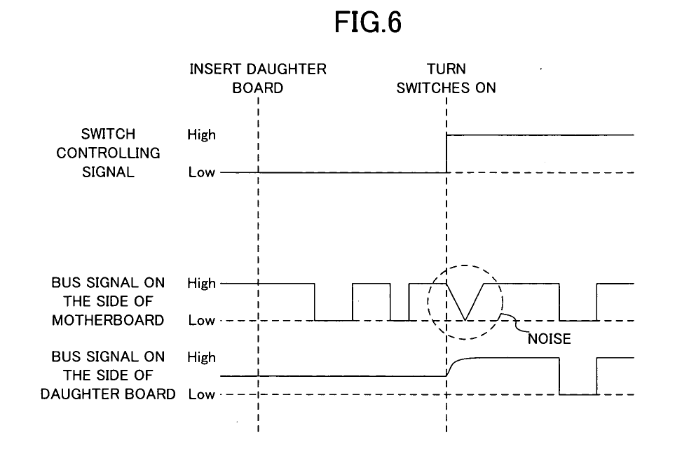

When the drivers 42 are turned on in step S21, the bus signal on the daughter board follows the bus signal on the motherboard. In this condition, such noise as shown in FIG. 6 or FIG. 8 is not generated whenever the switches 41 are turned on, because the bus signal on the daughter board and the bus signal on the motherboard are almost at the same potential. The control unit 31 therefore need not monitor the PCI bus control signal as in the third method that is a conventional method. While the data is being transferred in normal way after the daughter board is inserted, the on-resistances of the input terminals of the drivers 42 and the on-resistance of the switches 41 act on the bus signal lines. Nevertheless, these on-resistances do not influence the transfer of data since the drivers 42 has very high input impedance and the on-resistance of each switch 41 is extremely low.

In the present embodiment, the bus is a PCI bus. Nonetheless, this invention can be applied to buses of any other types. Although the daughter board is inserted into the motherboard in the present embodiment, this invention can be applied to the case where devices are connected by cables.

The bus communication apparatus corresponds to the daughter board 2 used in the embodiment. The external apparatus corresponds to the motherboard 1 used in the embodiment. The device corresponds to the PCI device 21 used in the embodiment. The bus signal terminal corresponds to the bus signal terminals 25. Further, the step of connecting the bus signal terminals corresponds to step S13 performed in the embodiment. The step of starting the drivers corresponds to step S21 carried out in the embodiment. The step of connecting switches corresponds to step S22 performed in the embodiment. The step of stopping the drivers corresponds to step S23 performed in the embodiment.

What is claimed is:

1. A bus communication apparatus designed to connect a device to an external apparatus via the bus of the external apparatus, thereby to perform communication with the external apparatus, while the bus is operating in the external apparatus, said communication apparatus comprising:
a bus signal terminal that can be connected to the bus of the external apparatus;
a device that communicates with the external apparatus through the bus;
a driver that is connected at an input terminal to the bus signal terminal and at an output terminal to the device, has an input impedance much higher than the impedance that the bus signal terminal has with respect to the input terminal and an output impedance much lower than the impedance that the device has with respect to the output terminal, while the bus signal terminal remains connected to the external apparatus, and operates in accordance with an instruction supplied externally, in order to decrease a potential difference between the input terminal and the output terminal;
a switch that connects the bus signal terminal to the device in accordance with a connection instruction supplied externally; and
a control unit that instructs the driver to start operating, then instructs the switch to perform connection and instructs the driver to stop operating, after the bus signal terminal is connected to the external apparatus.

2. The bus communication apparatus according to claim 1, wherein the control unit instructs the driver to start operating, after the device is prepared to operate.

3. The bus communication apparatus according to claim 1, wherein the control unit waits for a predetermined time after instructing the driver to start operating, and then instructs the switch to perform the connection.

4. The bus communication apparatus according to claim 1, wherein the control unit instructs the driver to stop operating, immediately after instructing the switch to perform the connection.

5. The bus communication apparatus according to claim 3, wherein the control unit measures the predetermined time on the basis of a clock signal that the device uses.

6. The bus communication apparatus according to claim 5, wherein the predetermined time is half the cycle of the clock signal.

7. A bus communication method for use in a bus communication apparatus that is designed to connect a device to an external apparatus, thereby to perform communication with the external apparatus, while a bus is operating in the external apparatus, said method comprising:
a bus-signal terminal connecting step that connects a bus signal terminal provided in the bus communication apparatus, to the external apparatus;
a driver starting step that causes a driver to start operating, the driver being connected at an input terminal to the bus signal terminal and at an output terminal to the device that communicates with the external apparatus, having an input impedance much higher than the impedance that the external apparatus has with respect to the input terminal and an output impedance much lower than the impedance that the device has with respect to the output terminal, and being designed to operate in accordance with an instruction supplied externally, in order to decrease a potential difference between the input terminal and the output terminal;
a switch connecting step that causes a switch to connect the bus signal terminal to the external apparatus in accordance with a connection instruction supplied externally; and
a driver-stopping step that causes the driver to stop operating.

8. The bus communication method according to claim 7, wherein the driver starting step is performed after the device is prepared to operate.

9. The bus communication method according to claim 7, wherein the switch connecting step is performed upon lapse of a predetermined time after the driver starting step is performed.

10. The bus communication method according to claim 7, wherein the driver-stopping step is performed immediately after the switch connecting step is performed.

11. The bus communication method according to claim 9, wherein the predetermined time is measured on the basis of a clock signal that the device uses.

12. The bus communication method according to claim 11, wherein the predetermined time is half the cycle of the clock signal.
